(19) United States
(12) Patent Application Publication
(10) Pub. No.: US 2026/0015213 A1
(43) Pub. Date: Jan. 15, 2026

(54) Multipurpose Crossbeam for Lifting a Vehicle, Lifting System Provided Therewith, and Method for Lifting a Vehicle

(71) Applicant: Stertil B.V., Kootstertille (NL)

(72) Inventor: Arjen Eisma, Kootstertille (NL)

(21) Appl. No.: 19/262,225

(22) Filed: Jul. 8, 2025

(30) Foreign Application Priority Data
Jul. 9, 2024 (NL) 2038174

(51) Int. Cl. B66F 7/28; B66F 7/20

(52) U.S. Cl. CPC B66F 7/28; B66F 7/20

(57) ABSTRACT

The present invention relates to multipurpose crossbeam for lifting a vehicle, lifting system provided therewith, and method for lifting a vehicle.

The multipurpose crossbeam according to the invention includes
a carrier beam;
one or more vehicle supports that are provided to the carrier beam and are configured for engaging the vehicle; and
one or more carrier receivers that are configured for receiving one or more carrier legs of a lifting device, wherein the one or more carrier receivers are hingedly connected to the carrier beam.

### CROSS-REFERENCE TO RELATED APPLICATION

This application claims priority to The Netherlands Patent Application No. 2038174 filed Jul. 9, 2024, the disclosure of which is hereby incorporated by reference in its entirety.

### BACKGROUND OF THE INVENTION

### Field of the Invention

The present invention relates to a multipurpose crossbeam for lifting a vehicle, such as a truck, car, bus, agricultural machinery, trailer et cetera. Such crossbeams are typically used for so-called heavy-duty vehicles.

In practice, crossbeams are known for applications wherein a user wishes to engage a vehicle on other locations than a tire or rim. This is typically relevant for trailers, vehicles with low ground clearance, three-wheel vehicles such as street sweepers et cetera. Crossbeams are then applied to enable lifting such vehicles, including the so-called heavy-duty vehicles. In the lifting of such vehicles, crossbeams are often used in combination with “mobile” lifting columns. These lifting columns engage the crossbeam with their carrier and/or carrier legs for lifting the crossbeam and the associated vehicle.

### Description of Related Art

One of the problems with conventional lifting operations using conventional crossbeams relates to safety. Safety involves a safe lifting process/operation for the user, the vehicle that is lifted, the material that is used in the lifting operation, and other persons and items in the vicinity of the lifting operation.

A further problem relates to damage in situations wherein loads are incorrectly acting on the crossbeam and the associated lifting devices. For example, such incorrect load/force distribution may occur due to undesired height differences of carriers of the respective lifting devices and may result in collapse and/or breakdown of the crossbeam and/or lifting devices. This may lead to injuries, damage and/or a standstill of the operation.

### SUMMARY OF THE INVENTION

The present invention has for its object to obviate or at least reduce one or more of the above stated problems by providing a multipurpose crossbeam for lifting a vehicle.

The present invention provides for this purpose a multipurpose crossbeam for lifting a vehicle according to the invention, the multipurpose crossbeam comprising:
a carrier beam;
one or more vehicle supports that are provided to the carrier beam and are configured for engaging the vehicle; and
one or more carrier receivers that are configured for receiving one or more carrier legs of a lifting device, wherein the one or more carrier receivers are hingedly connected to the carrier beam.

According to the invention the crossbeam comprises a carrier beam for carrying the vehicle and distributing the forces/loads that act on the crossbeam when lifting the vehicle. The carrier beam is provided with a number of vehicle supports that are configured for engaging the vehicle to be lifted. The number of vehicle supports is typically two per crossbeam. However, depending on the vehicle to be lifted, additional vehicle supports can be applied.

In addition, the carrier beam is operatively connected to a number of carrier receivers. These carrier receivers are configured for receiving one or more carrier legs of a lifting device. Such a lifting device can relate to any appropriate lifting device, typically including a lifting column and preferably a mobile lifting column. Such (mobile) lifting column is typically provided with a carrier that can be moved vertically when lifting and lowering a vehicle. For this purpose, the carrier is preferably provided with one or more carrier legs. Typically, each carrier is provided with two carrier legs that may engage on the vehicle directly or indirectly when using the crossbeam according to the present invention. In such a situation, the carrier legs specifically engage to the carrier receivers of the crossbeam. In a typical setup of a lifting system for lifting a vehicle involving the use of the multipurpose crossbeam according to the present invention, two lifting devices are used that engage on the carrier receivers that are preferably attached to the carrier beam of the crossbeam. When lifting a vehicle, the respective carriers of the lifting devices preferably move simultaneously.

According to the present invention, the one or more carrier receivers are hingedly connected to the carrier beam. Hingedly connecting the lifting device, directly or indirectly, to the carrier beam guarantees a safe load distribution by the crossbeam over the lifting devices, also in case of undesired height differences between the respective carriers of the lifting devices. The hingedly connecting of the carrier receivers to the carrier beam therewith obviates or at least reduces the risk of undesired point loads and/or load peaks and/or uneven load distributions. This prevents unsafe lifting operations that may result in injuries and/or damage to parts or devices or vehicles. Therefore, the multipurpose crossbeam with carrying receivers that are hingedly connected to the carrier beam improves the overall safety when lifting a vehicle and reduces the risk of breakdown(s) of the equipment.

In a presently preferred embodiment of the invention, the one or more carrier receivers are operatively connected to a carrier shaft configured for hingedly connecting to one or more carrier receivers to the carrier.

Providing a carrier shaft enables an operative hinged connection between the carrier receivers and the carrier beam that is both stable and robust. In addition, the use of a carrier shaft provides a relatively simple configuration of a hinged connection. Such carrier shaft requires minimal maintenance and allows for visual inspection during its lifetime.

In presently preferred embodiments of the invention, the carrier shaft extends in a substantially horizontal direction. This enables the carrier receivers to rotate in a substantially vertical plane. This further obviates or at least further reduces the risk of undesired point loads and/or load peaks and/or uneven load distributions. This further contributes to preventing unsafe lifting operations that may result in injuries and/or damage to parts or devices or vehicles. The hinge shaft further preferably extends in a substantially horizontal direction that is perpendicular to the length direction of the carrier beam.

In one of the presently preferred embodiments of the invention, the crossbeam comprises a carrier frame that comprises two carrier receivers and one carrier shaft. Such embodiment enables providing one carrier frame for each individual mobile lifting column having two carrier legs such that each carrier receiver is capable of receiving one of the two carrier legs of the respective lifting column. Preferably, a multipurpose crossbeam according to such embodiment is provided with two carrier frames that each comprise two carrier receivers among carrier shaft, such that the multipurpose crossbeam (and the vehicle) can be lifted with two mobile lifting columns.

In a preferred embodiment of the invention, the carrier receivers extend in a direction that is substantially perpendicular to the length direction of the carrier beam.

Having the carrier receivers extending in a direction perpendicular to the carrier beam enables lifting of the vehicle from its front or back side. Also, lifting capacity is increased due to the reduced bending of the carrier beam in a lifting operation. This is caused by the engagement of the carrier legs more towards the centre of the carrier beam as compared to a configuration wherein the lifting devices engage the crossbeam from its outer ends with carrier receivers extending parallel to the carrier beam. Furthermore, lifting the vehicle from front and/or back reduces issues with doors, mirrors, and other vehicle parts, and additionally involves less space requirements in the width direction of the vehicle to be lifted.

Preferably, the multipurpose crossbeam comprises one or more coupling elements configured for coupling the crossbeam to the vehicle.

Providing the crossbeam with coupling elements ensures a correct and safe coupling of the vehicle to the multipurpose crossbeam according to the invention. In a presently preferred embodiment, the coupling elements are configured for coupling to adapter eyes of the vehicle. Such adapter eyes can also be referred to as tie-down eyes that are provided to the vehicle. This provides a safe and reliable lifting operation of the respective vehicle.

In a further preferred embodiment of the multipurpose crossbeam according to the invention, the crossbeam comprises carrier surfaces at or near respective ends of the carrier beam, wherein the carrier surfaces are configured for engaging a carrier and/or other parts of a lifting device.

Providing carrier surfaces at or near respective ends of the carrier beam enables lifting devices, such as mobile lifting columns, to engage at or near the end of the carrier beam for lifting a vehicle from the side of the respective vehicle. This improves the flexibility of using the multipurpose crossbeam according to the present invention.

In a further preferred embodiment of the invention, the multipurpose crossbeam further comprises a number of side legs that extend in a direction that is substantially perpendicular to the length direction of the carrier beam.

Providing one or more side legs improves the support of the crossbeam and enables a more stable standing and displacement of the crossbeam. Preferably, the carrier beam of the crossbeam is provided with at least one side leg extending to each side of the carrier beam. More preferably, the side legs comprise a set of wheels. Providing wheels to the side legs renders displacing the multipurpose crossbeam easier and more user-friendly. This further improves the overall flexibility when using the multipurpose crossbeam according to the present invention.

In a further preferred embodiment of the invention, the multipurpose crossbeam further comprises an extended adapter.

In practice, when wheels of the vehicle to be lifted are too close to the end of the vehicle chassis, direct lifting of the vehicle with the crossbeam is difficult or even impossible. This can be solved by temporarily extending the chassis of the vehicle with the extended adapter. Such extended adapter can also be referred to as extended pin adapter and is optionally capable of being mounted to the vehicle and enabling engagement with the crossbeam to lift the vehicle. The extended adapter has a further effect in that it provides the load more to the centre of the carrier beam. This further improves safety and enables a reliable lifting operation.

It is noted that the extended adapter can also be applied to conventional crossbeams independent of the direct or indirect hinged connection of the carrier receivers to the carrier beam.

In a further preferred embodiment of the invention, the crossbeam further comprises a vehicle adapter.

A vehicle adapter supports the engagement of the vehicle, and specifically supports the relevant parts thereof. Depending on the vehicle type and the intended (maintenance) operation, it may be required to engage a specific vehicle part. The vehicle adapter provides flexibility to the crossbeam according to the present invention to engage such specific vehicle part.

In a further preferred embodiment of the invention, the multipurpose crossbeam further comprises a side-shift mechanism.

The side-shift mechanism enables displacing and (re) positioning of the vehicle supports along at least a part of the length of the carrier beam. This improves the overall flexibility of the multipurpose crossbeam according to the present invention for lifting a wide range of vehicles.

In a further preferred embodiment of the invention, the multipurpose crossbeam further comprises a load indicator.

Providing a load indicator to the crossbeam provides additional information on the loads that are actually working on the crossbeam. This additional information improves the overall safety as corrective measures can be taken by an operator and/or a warning signal can be generated. Optionally, in addition or as an alternative, an indicator can also be provided on the lifting device, such as on the carrier thereof. Also optionally, indications can be provided to the user in case of an overload situation.

The invention further relates to a lifting system for lifting a vehicle, wherein the lifting system comprises a number of lifting devices and a multipurpose crossbeam according to an embodiment of the present invention.

Such lifting system provides the same or similar effects and advantages as described in relation to the crossbeam.

In one of the presently preferred embodiments of the invention, the lifting devices comprise one or more mobile lifting columns. Using mobile lifting columns in combination with the multipurpose crossbeam provides a flexible lifting system that can be used for lifting a wide range of vehicle types.

The invention further also relates to a method for lifting a vehicle, wherein the method comprises the steps of:
providing a multipurpose crossbeam and/or lifting system according to an embodiment of the present invention;
positioning one or more lifting devices relative to the crossbeam; and
lifting the vehicle.

Such method provides the same or similar effects and advantages as described in relation to the multipurpose crossbeam and/or lifting system that is provided with such crossbeam.

Preferably, the method also comprises the additional step of stabilising a load with the hinged connection between the one or more carrier receivers and the carrier beam. This provides a safe and robust configuration capable of lifting a vehicle.

In a presently preferred embodiment of the invention, the carrier beam is connected to the carrier frame that has two carrier leg receivers and one shaft. By providing two carrier frames the multipurpose crossbeam can be lifted with the use of two mobile lifting columns.

### BRIEF DESCRIPTION OF THE DRAWINGS

The terms FIG., FIGS., Figure, and Figures are used interchangeably in the specification to refer to the corresponding figures in the drawings.

Further advantages, features and details of the invention are elucidated on the basis of preferred embodiments thereof, wherein reference is made to the accompanying drawings, in which:

FIG. 1 shows the multipurpose crossbeam according to an embodiment of the invention in cooperation with lifting devices in a lifting system;

FIG. 2 shows the crossbeam of FIG. 1 in a front view;

FIG. 3 shows the crossbeam of FIGS. 1-2 in a top view;

FIG. 4 shows the crossbeam of FIGS. 1-3 in a bottom view;

FIG. 5 shows the crossbeam of FIGS. 1-4 in a rear view;

FIGS. 6-7 show the crossbeam of FIGS. 1-5 at respective side views;

FIG. 8 shows the crossbeam of FIGS. 1-7 when being engaged by lifting columns with their carrier legs from the side of the cross beam;

FIG. 9 shows the crossbeam of FIGS. 1-7 when being engaged by lifting columns with their carriers at the carrier surfaces of the crossbeam; and

FIG. 10 shows the crossbeam with extended adapter.

### DESCRIPTION OF THE INVENTION

The following description is merely exemplary in nature and is in no way intended to limit the invention, its application, or uses. While the disclosure is described as having exemplary attributes and applications, the present disclosure can be further modified. This application is therefore intended to cover any variations, uses, or adaptations of the disclosure using its general principles.

Further, this application is intended to cover such departures from the present disclosure as come within known or customary practice of those skilled in the art to which this disclosure pertains and which fall within the limits of the appended claims. Accordingly, the following description of certain embodiments and examples should be considered merely exemplary and not in any way limiting.

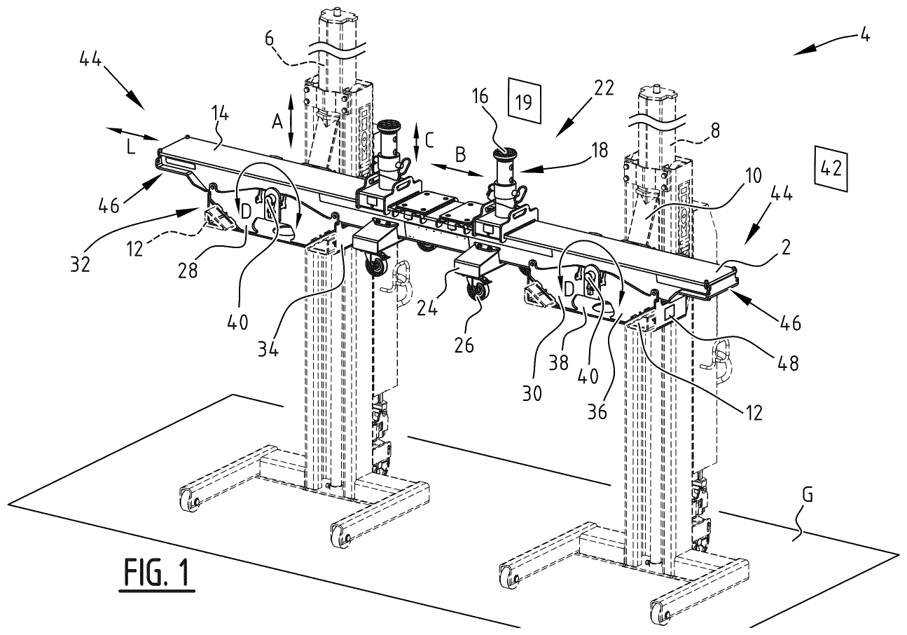

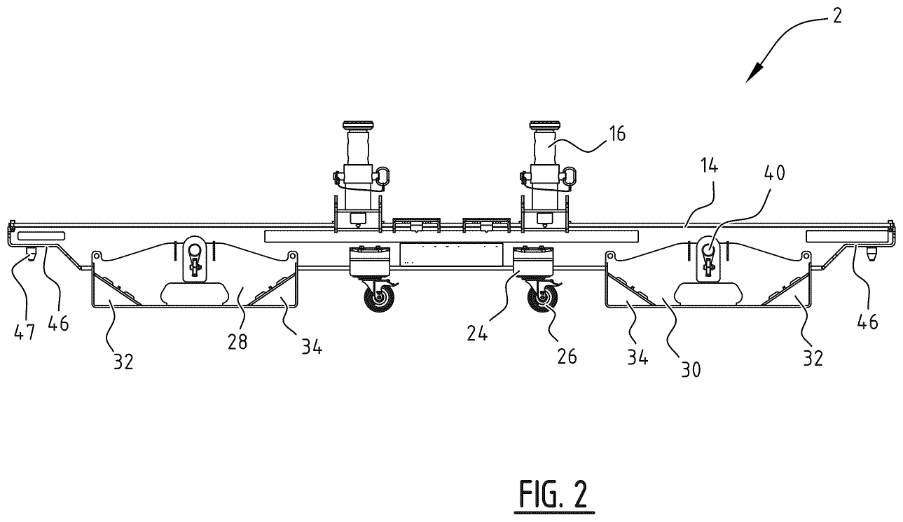

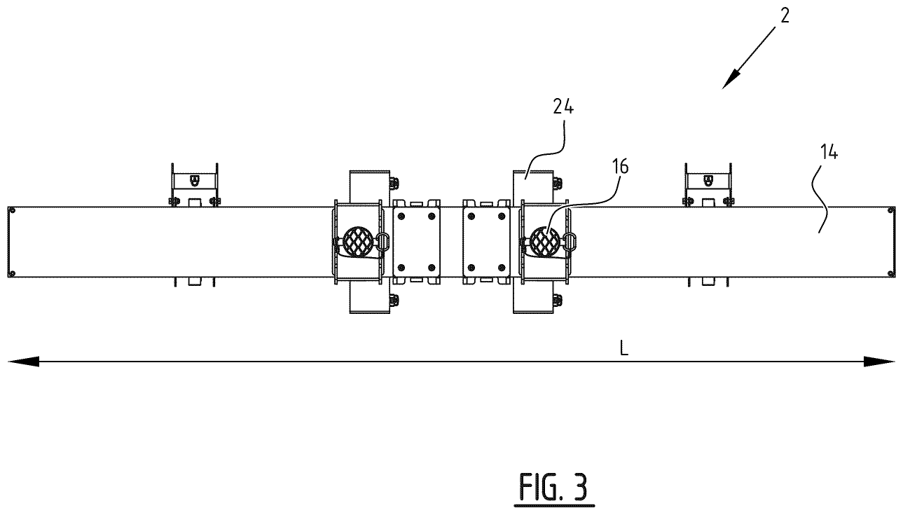

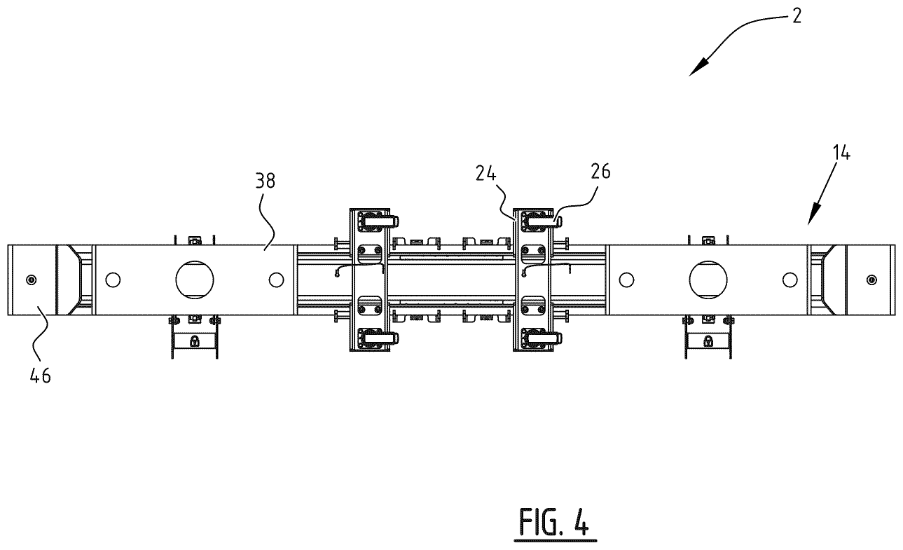

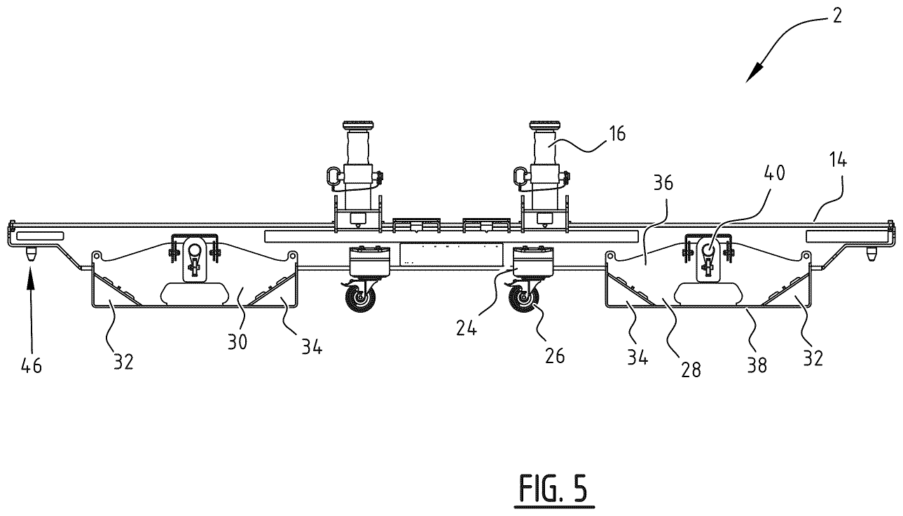

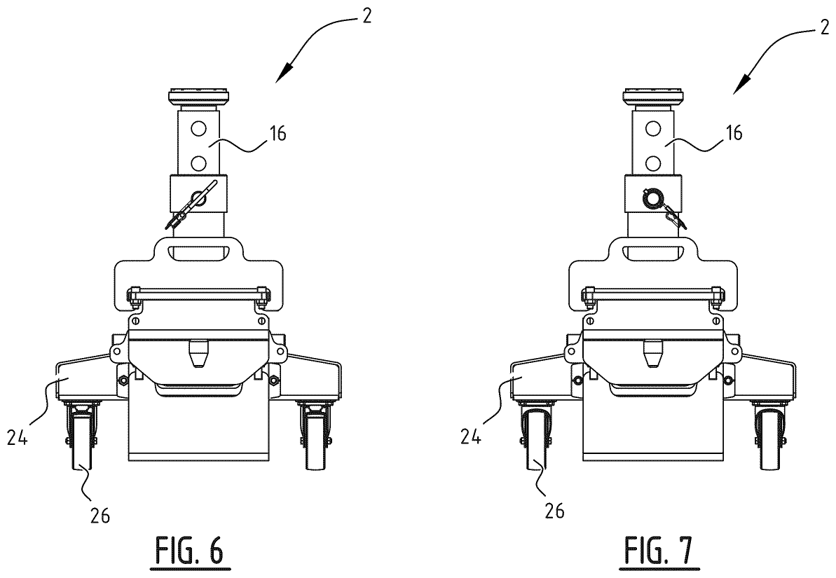

Multipurpose crossbeam 2 (FIG. 1-10) can be part of lifting system 4 that further comprises a number of lifting devices 6, 8. In the illustrated embodiment, lifting devices 6, 8 are mobile lifting columns having carrier 10, each carrier 10 is provided with two carrier legs 12. In the illustrated embodiment, lifting device 6, 8 rests on ground G. Lifting device 6, 8 enable lifting crossbeam 2 in direction A.

Crossbeam 2 comprises carrier beam 14 extending in length direction L. Carrier beam 14 is provided with vehicle supports 16 that are configured for engaging a vehicle. In the illustrated embodiment there are provided two vehicle supports 16 that are each provided with height adjuster 18 to adjust the height of support 16 relative to carrier beam 14. Optionally, vehicle adapter 18 (schematically illustrated in FIG. 1) can be used to adapt vehicle support 16 for engaging a specific part of vehicle 20.

In the illustrated embodiment, multipurpose crossbeam 2 further comprises side-shift mechanism 22 capable of (re) positioning vehicle supports 18. Vehicle supports 16 can be positioned at an appropriate location along crossbeam 2 with the aid of side-shift mechanism 22. This enables repositioning supports 16 and amending distance B between two supports 16. Optional height adjuster(s) 18 enables raising or lowering support 16 relative to carrier beam 14 in direction C.

Furthermore, in the illustrated embodiment, carrier beam 14 is provided with two pairs of side legs 24, wherein each pair of side legs 24 is provided with a set of wheels 26 to enable easy displacement of crossbeam 22 over ground G.

Also, in the illustrated embodiment, crossbeam 2 comprises first carrier frame 28 and second carrier frame 30. Each of carrier frames 28, 30 comprise first carrier leg receiver 32 and second carrier legs receiver 34 that are configured for receiving one of carrier legs 12. Carrier frames 28, 30 are optionally manufactured from plate material and may comprise side plate 36 and bottom plate 38, for example. In this embodiment, carrier frames 28, 30 are provided with hinge shaft 40 that enables rotation of carrier frame 28, 30 in direction D relative to carrier beam 14. Hinge shaft 40 extends in a substantially horizontal direction, preferably in a direction that is perpendicular to length direction L of carrier beam 14. Carrier leg receivers 32, 34 are preferably shaped as box profiles. It will be understood that other shapes and configurations can also be envisaged in accordance with the present invention.

For control the lifting operation, in the illustrated embodiment controller 42 (schematically illustrated in FIG. 1) can be used. Controller 42 can be integrated in one or more of lifting devices 6, 8 and/or may relate to a separate (remote) control and/or can be integrated in an overall control system.

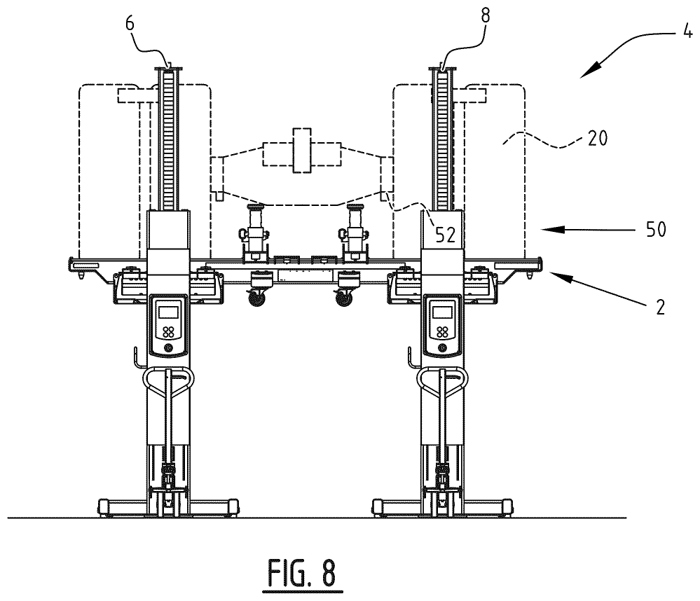

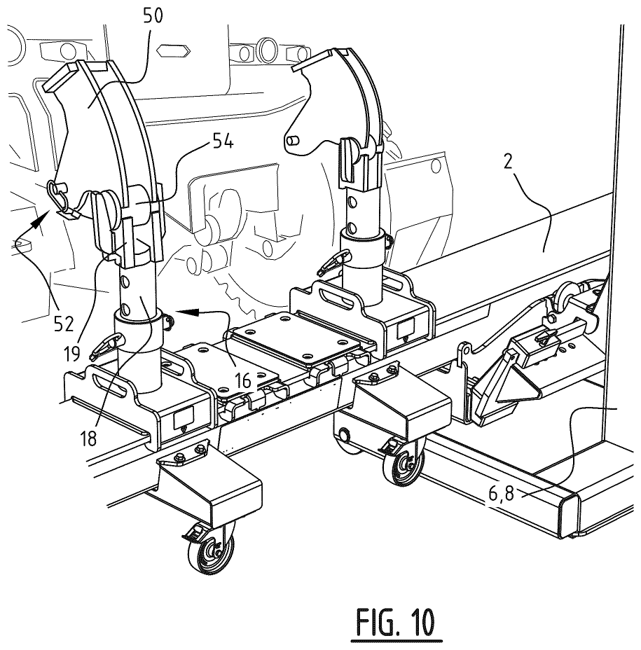

In the illustrated embodiment at or near end 44 of carrier beam 14, carrier surfaces 46 are provided that substantially face in a downwards direction towards ground G and allow for engagement with lifting devices 6, 8 at or near ends 44 of carrier beam 14 to further increase flexibility of crossbeam 2. In this embodiment, positioning pen 47 is provided on or in carrier surface 46. In one of the illustrated embodiments, carrier plate 49 is provided to carrier legs 12 to provide support to carrier surface(s) 46. Optionally, load sensor 48 (schematically illustrated in FIG. 1) can be provided to carrier frame 28, 30. It will be understood that other locations for load sensor 48 can also be envisaged in accordance with the present invention, including locations on lifting devices 6, 8. Also, vehicle 20 can be provided with adapter eyes or tie-down eyes 52 (schematically illustrated in FIG. 8). Optionally, extending pin adapter 50 (FIG. 10) can be provided to further improve the flexibility of multi-purpose crossbeam 2 for lifting vehicle 20. Extending pin adapter 50 is mounted to adapter eyes or tie-down eyes 52. Adapter contact element 54 is engaged by adapter 19 that can be lifted by supports 16.

When starting a lifting operation of vehicle 20, multipurpose crossbeam 2 is provided. Lifting columns 6, 8 engage crossbeam 2. This engagement may involve moving carrier legs 12 of carrier 10 of mobile lifting columns 6, 8 into respective profiles of carrier leg receivers 32, 34 of crossbeam 2 to enable lifting crossbeam 2 (and vehicle 20) in direction A. Vehicle supports 16 are positioned at the desired locations along length L of carrier beam 14 and are set at the desired height with height adjuster 18. After positioning respective supports 16 at the correct mutual distance B and the correct height C, support 16 may engage respective parts of vehicle 20 to enable lifting the vehicle. Optionally, vehicle adapter 19 can be used (example shown in FIG. 10).

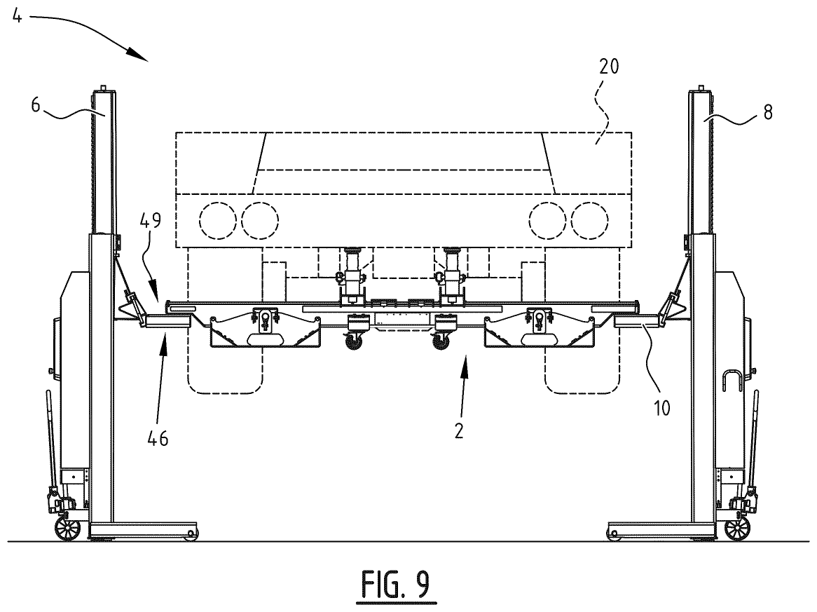

When lifting vehicle 20 with crossbeam 2, height differences between respective carriers 10 of lifting devices 6, 8 may influence the load distribution over carrier beam 14 and crossbeam 2. This is counteracted by allowing carrier frames 28, 30 to rotate around shaft 40 in direction D such that height differences between carriers 10 of lifting columns 6, 8 are compensated. Engaging carrier frames 28, 30 with lifting devices 6, 8 enables lifting vehicle 20 from the front or rear (FIG. 8). Optionally, or in addition thereto, carriers 10 of lifting columns 6, 8 may engage carrier surface 46 to enable lifting vehicle 20 with lifting device 6, 8 positioned on the sides of vehicle 20 (FIG. 9).

The present invention is by no means limited to the above-described preferred embodiments thereof. The rights sought are defined by the following claims within the scope of which many modifications can be envisaged.

1. A multipurpose crossbeam for lifting a vehicle, the crossbeam comprising:
a carrier beam;
one or more vehicle supports that are provided to the carrier beam and are configured for engaging the vehicle; and
one or more carrier receivers that are configured for receiving one or more carrier legs of a lifting device, wherein the one or more carrier receivers are hingedly connected to the carrier beam.

2. The multipurpose crossbeam according to claim 1, wherein the one or more carrier receivers are operatively connected to a carrier shaft configured for hingedly connecting the one or more carrier receivers to the carrier beam.

3. The multipurpose crossbeam according to claim 2, wherein the carrier shaft extends in a substantially horizontal direction.

4. The multipurpose crossbeam according to claim 2, further comprising a carrier frame that comprises two carrier receivers and one carrier shaft.

5. The multipurpose crossbeam according to claim 3, further comprising a carrier frame that comprises two carrier receivers and one carrier shaft.

6. The multipurpose crossbeam according to claim 1, wherein the carrier receivers extend in a direction that is substantially perpendicular to the length direction of the carrier beam.

7. The multipurpose crossbeam according to claim 5, wherein the carrier receivers extend in a direction that is substantially perpendicular to the length direction of the carrier beam.

8. The multipurpose crossbeam according to claim 1, further comprising one or more coupling elements configured for coupling to the vehicle.

9. The multipurpose crossbeam according to claim 1, wherein the coupling elements are configured for coupling to adapter eyes of the vehicle.

10. The multipurpose crossbeam according to claim 1, further comprising carrier surfaces at or near respective ends of the carrier beam that are configured for engaging a carrier of a lifting device.

11. The multipurpose crossbeam according to claim 1, further comprising a number of side legs that extend in a direction that is substantially perpendicular to the length direction of the carrier beam.

12. The multipurpose crossbeam according to claim 1, further comprising a set of wheels.

13. The multipurpose crossbeam according to claim 1, further comprising an extended adapter.

14. The multipurpose crossbeam according to claim 1, further comprising a vehicle adapter.

15. The multipurpose crossbeam according to claim 1, further comprising a side-shift mechanism.

16. The multipurpose crossbeam according to claim 1, further comprising a load indicator.

17. A lifting system for lifting a vehicle, the lifting system comprising a number of lifting devices and a multipurpose crossbeam comprising:
a carrier beam;
one or more vehicle supports that are provided to the carrier beam and are configured for engaging the vehicle; and
one or more carrier receivers that are configured for receiving one or more carrier legs of a lifting device, wherein the one or more carrier receivers are hingedly connected to the carrier beam.

18. The lifting system according to claim 17, wherein the lifting devices comprise one or more mobile lifting columns.

19. A method for lifting a vehicle, the method comprising the steps of:
providing a multipurpose crossbeam and/or lifting system comprising such multipurpose crossbeam comprising:
a carrier beam;
one or more vehicle supports that are provided to the carrier beam and are configured for engaging the vehicle; and
one or more carrier receivers that are configured for receiving one or more carrier legs of a lifting device, wherein the one or more carrier receivers are hingedly connected to the carrier beam;
positioning one or more lifting devices relative to the crossbeam; and
lifting the vehicle.

20. The method according to claim 19, further comprising the step of stabilizing a load with the hingedly connection between the one or more carrier receivers and the carrier beam.
